(19) United States
(12) Patent Application Publication
(10) Pub. No.: US 2026/0304387 A1
(43) Pub. Date: Oct. 1, 2026

(54) Method and apparatus for performing sensing and communication in a wireless communication system

(71) Applicant: HANBAT NATIONAL UNIVERSITY INDUSTRY-ACADEMIC COOPERATION FOUNDATION, Daejeon (KR)

(72) Inventors: Eunkyung KIM, Daejeon (KR); Gosan NOH, Daejeon (KR)

(21) Appl. No.: 19/577,737

(22) Filed: Mar. 25, 2026

(30) Foreign Application Priority Data
Mar. 26, 2025 (KR) 10-2025-0038492
Mar. 3, 2026 (KR) 10-2026-0037828

(51) Int. Cl. H04W 72/044; G01S 13/00

(52) U.S. Cl. CPC H04W 72/044; G01S 13/003

(57) ABSTRACT

The present disclosure provides a method for performing communication and sensing in a wireless communication system supporting ISAC, the method performed by a transmitting base station includes transmitting first configuration information related to configuration for the communication and second configuration information related to configuration for the sensing to at least one of a receiving base station and a neighboring base station; determining wireless resources used for the communication and the sensing; transmitting a radio signal to the receiving base station on the wireless resources; and receiving a result for the sensing from the receiving base station.

### CROSS-REFERENCE TO RELATED APPLICATION

This application claims the benefit of and priority to Korean Patent Application No. 10-2025-0038492, filed on Mar. 26, 2025, and Korean Patent Application No. 10-2026-0037828, filed on Mar. 3, 2026, the entire disclosure(s) of which is hereby incorporated herein by reference in its entirety.

### TECHNICAL FIELD

The present disclosure relates to a wireless communication system, and more specifically, to a method for performing communication and sensing in a wireless communication system that supports integrated sensing and communication (ISAC).

### BACKGROUND

With the standardization of 3rd Generation Partnership Project (3GPP), high-quality mobile communication services have been realized by 5G mobile communication. Such a system needs to satisfy various requirements such as enhanced mobile broadband (eMBB), massive machine-type communication (mMTC), and ultra-reliable and low-latency communication (URLLC), and to this end, achieve a performance target in a dense user equipment environment as well as high data transmission rate, low latency, and high reliability. Further, 5G aims to expand to application services such as Internet of things (IoT), vehicle-to-everything (V2X), and non-terrestrial networks (NTN).

The ITU-R has clearly defined technical requirements for IMT-2030 in order to present a vision for 6G mobile communication. Beyond the scope of existing eMBB, mMTC, and URLLC, innovations such as immersive communication, massive communication, and hyper reliable and low-latency communication are pursued. Further, the development in various areas such as integration of sensing and communication for communication convergence services, AI and communication, and ubiquitous connectivity is aimed at.

In particular, integrated sensing and communication (ISAC), which is one of key scenarios of 6G, means integration of sensing technology and communication technology. ISAC technology plays a significant role in various application fields such as autonomous vehicles, smart cities, and Internet of Things (IoT), and contributes to enabling collection and transmission of data to be performed more efficiently.

The ISAC technology is utilized for detection of objects and intruders in various environments, and for various purposes such as collision avoidance, path tracking, vehicle driving support, public safety, environmental monitoring, and health care. For example, the ISAC technology provides a function of detecting an intruder in a smart home environment and approach of pedestrians and animals in a highway and railway section to prevent potential accidents. In a smart factory, the ISAC technology detects robots or moving bodies to contribute to improving the safety of a working environment. Further, the ISAC is applied to collision avoidance and path tracking of uncrewed aerial vehicles (UAVs), vehicles, and automated guided vehicles (AGVs), and supports a positioning function through 5G and 6G systems.

Sensing information based on 5G and 6G can be utilized to improve a behavior of a vehicle, and various types of sensor data can be integrated to provide more accurate information. The ISAC is utilized for searching for missing persons and tracking of criminal suspects, and provides head-up display (HUD) information to firefighters at a fire site to improve efficiency of rescue activities. Further, The ISAC can detect flooding due to heavy rainfall to issue a flood warning and contribute to preventing casualties in advance. The ISAC includes a function of monitoring a respiratory condition through a sleep monitoring service, checking a health condition using a 5G signal without equipment, and detecting a movement or a fall in a house. These technologies are expected to provide practical safety and efficiency in various application fields.

### SUMMARY

An object of the present disclosure is to provide an operation method for base station-to-base station bistatic sensing in order to perform communication and sensing in an integrated sensing and communication (ISAC) system, and a signal transmission and reception method.

The objects to be achieved in the present disclosure are not limited to the object mentioned above, and other objects that are not mentioned may be clearly understood by those skilled in the art to which the present disclosure pertains from the description below.

The present disclosure provides a method for performing communication and sensing in a wireless communication system supporting integrated sensing and communication (ISAC), the method performed by a transmitting base station including: transmitting first configuration information related to configuration for the communication and second configuration information related to configuration for the sensing to at least one of a receiving base station and a neighboring base station; determining wireless resources used for the communication and the sensing; transmitting a radio signal to the receiving base station on the wireless resources; and receiving a result for the sensing from the receiving base station.

Further, in the present disclosure, the result for the sensing includes at least one of information on presence or absence of a sensed object, information on the number of sensed objects, information on a size of the sensed object, information on a distance to the sensed object, or information on a direction of the sensed object.

Further, in the present disclosure, the method performed by the transmitting base station further includes receiving a request for the sensing from a core network.

Further, in the present disclosure, the method performed by the transmitting base station further includes transmitting the result for the sensing to the core network.

Further, in the present disclosure, the wireless resources include resources related to transmission of a radio signal for the communication and resources related to reception of a radio signal for the sensing.

Further, in the present disclosure, the wireless resources include at least one of specific frequency resources, time resources, and beam resources.

Further, in the present disclosure, information on the wireless resources is included in the first configuration information or the second configuration information.

Further, in the present disclosure, the first configuration information and the second configuration information include at least one of a sensing mode identity for distinguishing between sensing modes, information on the number of target objects, information for target object distinguishment, information for distinguishing a base station performing sensing, frequency allocation information, time allocation information, bandwidth part (BWP) information, information on a waveform to be used, information on a slot format, information on a reference signal, information on multiple antennas, and information on beamforming.

Further, in the present disclosure, the first configuration information and the second configuration information are delivered via an Xn interface or are delivered over a core network via a core Ng interface.

Further, in the present disclosure, the sensing mode identity includes information indicating monostatic sensing or bistatic sensing.

Further, in the present disclosure, the sensing mode identity further includes information indicating base station monostatic sensing, user equipment monostatic sensing, base station-to-base station bistatic sensing, base station-to-user equipment bistatic sensing, user equipment-to-base station bistatic sensing, or user equipment-to-user equipment bistatic sensing.

Further, in the present disclosure, the information on the waveform to be used includes information indicating orthogonal frequency-division multiplexing (OFDM) or discrete frequency transform-spread-OFDM (DFT-s-OFDM).

Further, in the present disclosure, the information on the slot format includes arrangement information for downlink, uplink, sidelink, or flexible sections in a slot, and a slot format index for a plurality of predetermined slot format candidates.

Further, in the present disclosure, the information on multiple antennas includes information on the number of layers for multiple antenna transmission or the number of antennas.

Further, in the present disclosure, the information on beamforming includes a number of beams or a beam identity.

Further, the present disclosure provides a method for performing communication and sensing in a wireless communication system supporting integrated sensing and communication (ISAC), the method performed by a receiving base station including: receiving first configuration information related to configuration for the communication and second configuration information related to configuration for the sensing from a transmitting base station; receiving a radio signal on wireless resources used for the communication and the sensing; performing sensing based on the received radio signal; and transmitting a result for the sensing to the transmitting base station.

Further, in the present disclosure, the method performed by the receiving base station further includes transmitting the result for the sensing to a neighboring base station.

Further, the present disclosure, the method performed by the receiving base station further includes transmitting the result for the sensing to a core network core network.

Further, the present disclosure provides a transmitting base station for performing communication and sensing in a wireless communication system supporting integrated sensing and communication (ISAC), the transmitting base station including: a memory; a communication module for transmitting and receiving signals with an outside; and a processor functionally connected with the memory and the communication module to control an overall operation of the transmitting base station, wherein the processor performs control for transmitting first configuration information related to configuration for the communication and second configuration information related to configuration for the sensing to at least one of a receiving base station and a neighboring base station, determining wireless resources used for the communication and the sensing, transmitting a radio signal to the receiving base station on the wireless resources, and receiving a result for the sensing from the receiving base station.

The method proposed in the present disclosure has an effect of enabling a base station-to-base station bistatic integrated sensing-communication operation to be performed more stably and effectively.

The effects obtainable in the present disclosure are not limited to the effects mentioned above, and other effects that are not mentioned may be clearly understood by those skilled in the art to which the present disclosure pertains from the description below.

### BRIEF DESCRIPTION OF THE DRAWING

In order to help understanding of the present disclosure, the accompanying drawings included as a part of the detailed description provide embodiments of the present disclosure, and are used to describe technical features of the present disclosure together with the detailed description.

FIG. 1 illustrates an example of a structure of a 5G NR system to which a method proposed in the present disclosure may be applied.

FIG. 2 illustrates another example of the structure of the 5G NR system to which the method proposed in the present disclosure may be applied.

FIG. 3 illustrates examples of a sensing method in ISAC.

FIG. 4 is a diagram illustrating an example of a monostatic scheme and a bistatic scheme to which the method proposed in the present disclosure may be applied.

FIG. 5 is a diagram illustrating an example of a base station-to-base station bistatic scheme proposed in the present disclosure.

FIG. 6 is a flowchart illustrating an example of an operation for base station-to-base station bistatic sensing and a signal transmission and reception method proposed in the present disclosure.

FIGS. 7 and 8 are flowcharts illustrating other examples of the operation for base station-to-base station bistatic sensing and the signal transmission and reception method proposed in the present disclosure.

FIG. 9 is a block configuration diagram of a wireless apparatus according to an embodiment of the present disclosure.

### DETAILED DESCRIPTION

The technical terms used in the present disclosure are merely used to describe specific embodiments, and it should be noted that there is no intention to limit the spirit of the technology disclosed in the present disclosure. Further, unless the technical terms used in the present disclosure are particularly defined as having other meanings in the present disclosure, the technical terms should be construed as having meanings generally understood by those skilled in the art to which the technology disclosed in the present disclosure pertains, and should not be construed as having excessively comprehensive meanings or excessively reduced meanings. Further, when a technical term used in the present disclosure is an incorrect technical term that fails to accurately express the spirit of the technology disclosed in the present disclosure, the term should be replaced and understood with a technical term that can be correctly understood by those skilled in the art to which the technology disclosed in the present disclosure pertains. Further, general terms used in the present disclosure should be construed according to what is defined in dictionaries or according to contexts and should not be construed as having excessively reduced meanings.

Terms including ordinals such as first and second used in the present disclosure may be used to describe various components, but the components should not be limited by the terms. The terms are only used for the purpose of distinguishing one component from another component. For example, a first component may be named as a second component without departing from the scope of rights of the present disclosure, and similarly a second component may also be named as a first component.

Hereinafter, embodiments disclosed in the present disclosure will be described in detail with reference to the accompanying drawings, and the same or similar components are denoted by the same reference numerals regardless of the drawings and redundant descriptions thereof will be omitted.

Further, when it is determined that detailed description of related known technology may obscure the gist of the technology disclosed in the present disclosure in describing the technology disclosed in the present disclosure, the detailed description will be omitted. Further, it should be noted that the accompanying drawings are only provided to facilitate understanding the spirit of the technology disclosed in the present disclosure, and the spirit of the technology should not be construed as being limited by the accompanying drawings.

Among terms used in the present disclosure, “configuration” may be referred to as “operation,” “proposal,” “indication,” or the like, “transmission and reception” may be referred to as “Tx/Rx,” “transmission and reception,” or the like, and “A/B” may be construed as “at least one of A or B.”

The terms, concepts, procedures, and the like used in the present disclosure are briefly summarized as follows.

### (1) Definition of Terms

Sensing gNB: A sensing gNB is a base station having a sensing signal transmission and reception function.
Sensing CN: A sensing CN is a logical function of performing a sensing function (SF) in a core network.
One sensing gNB may include one or more sensing TRPs to perform a role as a transmission point or a reception point for a sensing signal.

(2) Sensing service procedure between a RAN and core network (CN): This may include a flow in which the sensing function (SF) in the core network instructs the sensing gNB of the RAN to perform a sensing task through a sensing request, and the sensing gNB performs environment sensing according to a corresponding resource configuration (or a sensing-related resource configuration) and then delivers a sensing result report to the core network.
When a sensing service request occurs in the core network, the SF discovers and selects a corresponding sensing gNB, sets a sensing session with the discovered sensing gNB, and delivers sensing configuration information to the sensing gNB.
The sensing gNB performs a sensing operation such as transmitting a target signal according to the received sensing configuration information and receiving reflected waves, and reports sensing results (for example, whether an object exists, or location information) processed from measured data to the SF.
The SF delivers a final sensing result to an upper service through additional post-processing if necessary.

(3) Distinguishment between a control plane and a user plane: Sensing control signals (for example, sensing session request/setting, and termination instruction) are processed with a control plane (CP) message for reliability and interworking, and the control plane or the user plane may be used for delivery of sensing data (report).

(4) Sensing resource management and TRP selection: When a sensing service is performed, a determination as to which TRP to utilize for transmission and reception may be performed by a gNB.

(5) Sensing data processing location: There is a need to define where to perform processing after reception of a sensing signal.
A primary processing function for the sensing data (for example, basic signal processing such as matched filtering, FFT, and peak detection, and object detection computation) may be placed at a gNB side such that only result information is transmitted to the core network.
Further, a model for integrated processing in the SF of the core network is conceivable. In this case, sensing data of several gNBs may be fused or a more complex algorithm may be applied.

The method proposed in the present disclosure may be applied to a user equipment, a base station, a radio access network (RAN), a core network, or the like of a wireless communication system based on 3GPP 5G NR or 6G in order to satisfy requirements for the ISAC. However, the method proposed in the present disclosure is not limited thereto, and is also applicable to other wireless communication systems based on long term evolution (LTE) or Institute of Electrical and Electronics Engineers (IEEE) 802 technology.

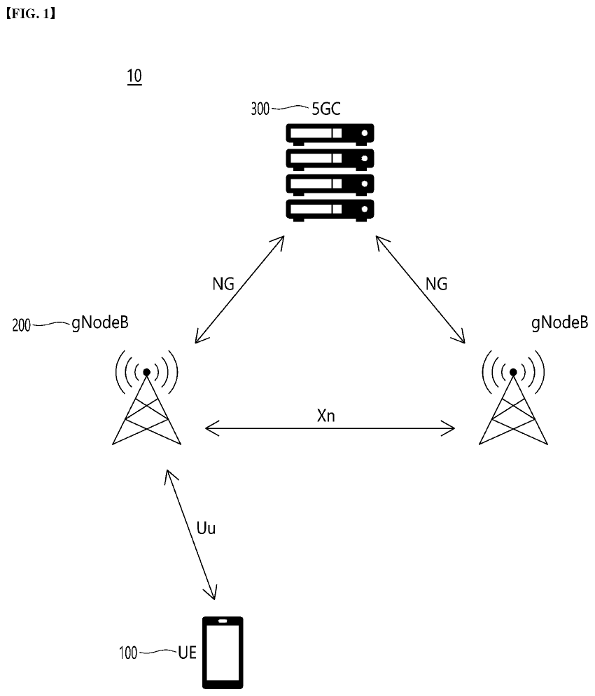

FIG. 1 illustrates an example of a structure of a 5G NR system to which the method proposed in the present disclosure may be applied.

Referring to FIG. 1, a radio access network of a 5G NR system (or a wireless communication system) 10 may include a user equipment 100, at least one base station 200, at least one core network 300, and the like.

The base station may include a gNodeB, an eNodeB, a transmission reception point (TRP), and the like. Between gNodeBs, connection may be made via the Xn interface.

The core network includes a 5G core network (5GC). The 5GC may be connected with a gNodeB via an NG interface, and between the gNodeB and a user equipment (UE), connection is made through a Uu interface in a wireless section.

The 5GC may support a service-oriented architecture, and may satisfy various network requirements by providing resources and services virtually separated through network slicing. Further, flexible utilization and distributed characteristics of network resources are realized through separation of the control plane (CP) and the user plane (UP). The 5GC may support the following functions:
Access and mobility management function (AMF): This is in charge of access and mobility management, user equipment authentication processing, and the like.
Session management function (SMF): Session management and IP address allocation are performed.
User plane function (UPF): This performs packet routing, forwarding, inspection, quality of service (QoS) processing, packet filtering, traffic measurement, and the like for user data processing, and serves as a gateway between the RAN and the Internet.
Network repository function (NRF): This performs search and registration management of network functions, and service discovery.
Policy control function (PCF): This serves to control policy management, QoS, and charging policies.

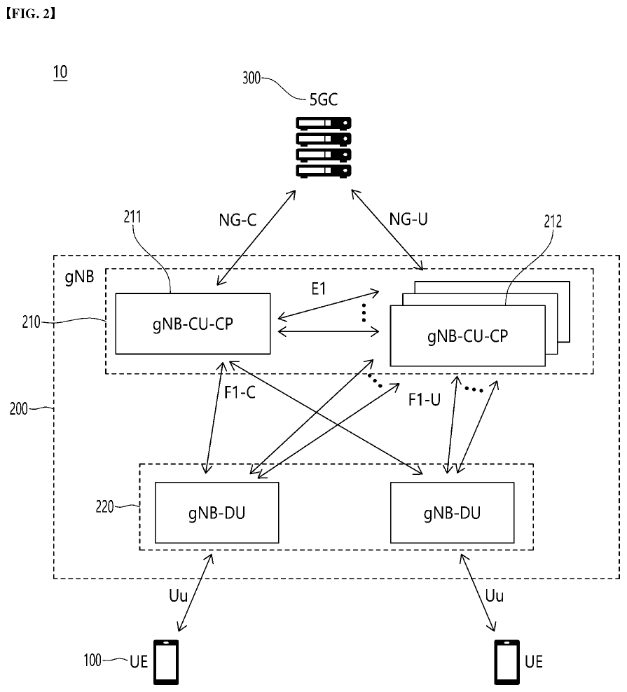

FIG. 2 illustrates another example of the structure of the 5G NR system to which the method proposed in the present disclosure may be applied.

As illustrated in FIG. 2, a gNodeB (or gNB) may include a central unit (CU) 210 and a distributed unit (DU) 220, and is generally designed to divide and perform operations of an L2 protocol. That is, the gNB may be separated into a gNB-CU and a gNB-DU. For example, the gNB-CU may include radio resource control (RRC), service data adaptation protocol (SDAP), and packet data convergence protocol (PDCP) layers, and the gNB-DU may include radio link control (RLC), medium access control (MAC), and physical (PHY) layers. Further, the gNB-CU may include a gNB-CU-CP 211 that performs a control plane function and a gNB-CU-UP 212 that performs a user plane function.

In the gNB, one gNB-CU-CP may be logically connected with a plurality of gNB-CU-UPs via an E1 interface, and one gNB-CU-CP is connected with several gNB-DUs via a F1-C interface. Further, several gNB-CU-UPs may be connected with a plurality of gNB-DUs through an F1-U interface. One gNB-DU is connected with one gNB-CU-CP, and one gNB-CU-UP may be connected with one gNB-CU-CP.

Interfaces between network nodes constituting each radio access network perform the following functions:
NG interface: This includes paging, user equipment context management, mobility management, protocol data unit (PDU) session management, non-access stratum (NAS) transmission, NAS node selection, NG interface management, alert message transmission, configuration delivery, access and mobility management function (AMF) management, AMF load balancing, location reporting, AMF relocation, radio capability management of a user equipment, and the like.
Xn interface: An Xn-C interface responsible for the control plane performs various functions such as Xn interface management, error processing, user equipment mobility management, dual connectivity, energy saving, and resource coordination, and an Xn-U interface responsible for the user plane serves as data transmission, flow control, provision of assistance information, high-speed retransmission, and the like.
F1 interface: An F1-C interface for processing a control plane performs functions such as F1 interface management, system information management, F1 user equipment context management, RRC message transmission, paging, alert message information delivery, and the F1-U interface responsible for a user plane performs functions such as user data transmission and flow control.
E1 interface: The E1 interface performs functions such as E1 management, E1 bearer context management, tracking, load management, and measurement result delivery.

Next, an ISAC operation applicable to a radio access network will be described with reference to related drawings.

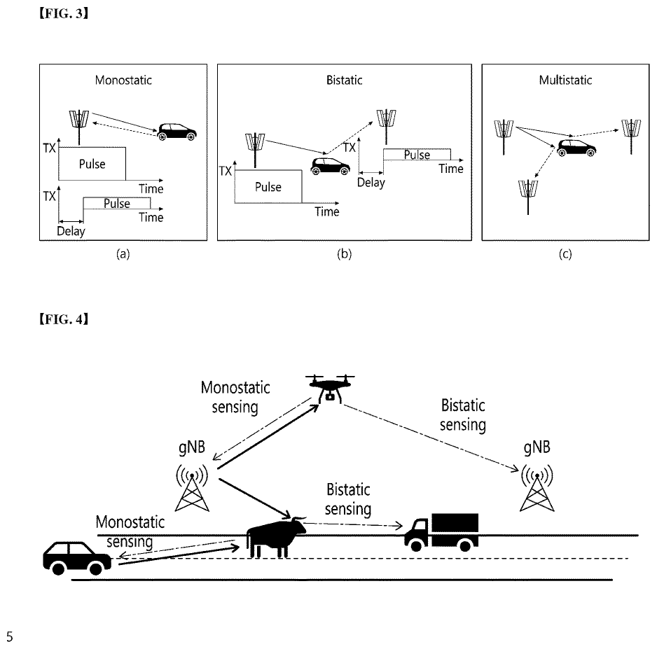

FIG. 3 illustrates examples of a sensing method in the ISAC. Specifically, FIG. 3a illustrates a monostatic scheme, FIG. 3b illustrates a bistatic scheme, and FIG. 3c illustrates a multistatic scheme.

The monostatic scheme of FIG. 3a is a scheme in which a transmission and reception node 1 and a transmission and reception node 2 exist at the same location or in the same apparatus and perform sensing through transmission and reception by themselves. The bistatic scheme of FIG. 3b is a scheme in which the transmission and reception node 1 and the transmission and reception node 2 exist at different locations or apparatuses and perform sensing through mutual transmission and reception. For example, the bistatic scheme may include sensing between a base station 1 and a base station 2, between RRHs connected to base stations, between a base station and a wired/wireless relay, between a user equipment and a base station, between the user equipment and the RRH, or between other communication nodes. The multistatic scheme of FIG. 3c is a scheme for performing sensing through three or more transmission and reception nodes installed at different locations or apparatuses, and includes simultaneous or sequential operation among a plurality of nodes, a cooperative and distributed sensing scheme, and modified schemes equivalent thereto.

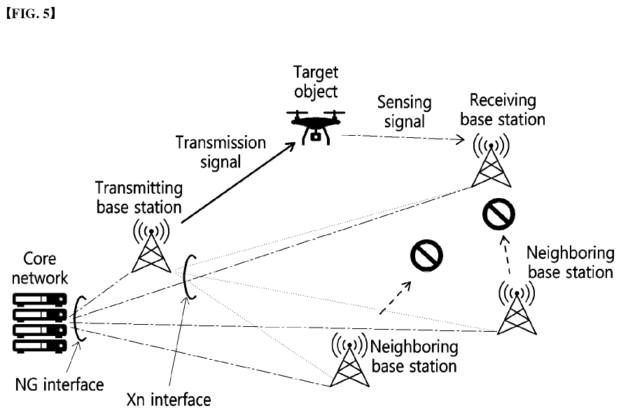

Next, The ISAC operation applicable to the radio access network will be described with reference to related drawings. When a 5G NR or 6G communication network is used for the purpose of object sensing, various scenarios as illustrated in FIG. 4 may be included. As described in FIG. 3, classification into a monostatic scheme and a bistatic scheme may be made depending on whether a transmitter and a receiver are operated at the same location. In the monostatic scheme, the transmitter and the receiver operate at the same point, and a sensing task is performed through this scheme in a base station or a user equipment. On the other hand, in the bistatic scheme, the transmitter and the receiver operate at different locations, and a bistatic sensing scheme between base stations, between a user equipment and a user equipment, or between the base station and the user equipment may be defined. Examples of the monostatic scheme and the bistatic scheme are as follows and illustrated in FIG. 4. FIG. 4 is a diagram illustrating an example of a monostatic scheme and a bistatic scheme to which the method proposed in the present disclosure may be applied.

Base station monostatic sensing: A process in which a radio signal transmitted from a specific base station is reflected by a target object, and a reflected signal is received again by the base station is sensed.

User equipment monostatic sensing: A process in which a radio signal transmitted from a specific user equipment is reflected by a target object, and a reflected signal is received again by the user equipment is sensed.

Base station-to-base station bistatic sensing: A process in which a radio signal transmitted from a specific base station is reflected by a target object, and then a reflected signal is received by another base station is sensed.

Base station-to-user equipment bistatic sensing: A process in which a radio signal transmitted from a specific base station is reflected by a target object, and a reflected signal is received by another user equipment is sensed.

User equipment-to-base station bistatic sensing: A process in which a radio signal transmitted from a specific user equipment is reflected by a target object, and a reflected signal is received by another base station is sensed.

User equipment-to-user equipment bistatic sensing: A radio signal transmitted from a specific user equipment is reflected by a target object, and a reflected signal is received by another user equipment is sensed.

In a sensing process using the ISAC, Measurement may be performed through an amount of a signal reflected from a target object, that is, a radar cross section (RCS), and this value is related to various elements such as a size, material, shape, and direction of the object.

Meanwhile, in the operation of the ISAC, interference may occur due to a sensing task and a communication task being simultaneously performed compared with a sensing-only system or a communication-only system. Such interference is classified into various types as follows.
Self interference: This is interference occurring in a process of receiving a signal for sensing while transmitting a communication signal. Such self interference may be caused by external reflected waves, or may be caused by power leakage in an antenna or an RF circuit inside a transceiver. Strength of the self interference is relatively much larger than strength of a received signal.
Mutual interference: This is interference occurring when a communication signal and a sensing signal share a time or a frequency band. In this case, communication performance or sensing performance may be degraded depending on relative strengths of the two signals.
Clutter: The sensing performance may be degraded due to clutter existing in a surrounding environment, in addition to the target object. The clutter may be classified into static clutter at a fixed location and non-static clutter that is movable.

Hereinafter, a base station-to-base station bistatic sensing method proposed in the present disclosure will be described.

Abase station operation for base station-to-base station bistatic sensing may include a cooperative operation of two or more base stations. In this case, a transmitting base station (or a first base station) may transmit a signal for sensing and/or communication. A sensing base station or a receiving base station (or a second base station) may sense an object from a signal received when the signal transmitted by the transmitting base station is reflected by the target object. In this case, the base station may perform a configuration for radio signal transmission and a configuration for sensing signal reception, and information related to such configuration may be transmitted and received through a control message or the like.

Examples of information that may be included in the configuration for radio signal transmission may include a sensing mode identity (ID), the number of target objects, a target object identifier, a transmitting base station identifier, a sensing base station identifier, frequency allocation information, time allocation information, bandwidth part (BWP) information, waveform-to-be-used information, a slot format, reference signal information, multiple antenna information, beamforming information, and the like.

Meanwhile, examples of information that may be included in the configuration for sensing signal reception include the sensing mode identity, the number of target objects, the target object identifier, the transmitting base station identifier, the sensing base station identifier, the frequency allocation information, the time allocation information, the BWP information, the waveform-to-be-used information, the slot format, the reference signal information, the multiple antenna information, the beamforming information, and the like.

The sensing mode identity may include monostatic sensing, bistatic sensing, and the like. Additionally, the sensing mode identity may include information indicating base station monostatic sensing, user equipment monostatic sensing, base station-to-base station bistatic sensing, base station-to-user equipment bistatic sensing, user equipment-to-base station bistatic sensing, or user equipment-to-user equipment bistatic sensing.

The information on the waveform to be used may include, for example, information indicating orthogonal frequency-division multiplexing (OFDM) or discrete frequency transform-spread-OFDM (DFT-s-OFDM).

The slot format may include arrangement information for downlink, uplink, sidelink, flexible sections, or the like in a slot, and may include a slot format index for a plurality of predetermined slot format candidates.

The information on multiple antennas may include the number of layers for multiple antenna transmission, the number of antennas, or the like. Further, the beamforming information may include the number of beams, a beam identity, or the like.

In one embodiment related to transmitting base station and receiving base station operations and signal delivery for base station-to-base station bistatic sensing, (1) a step in which the transmitting base station delivers configuration information related to signal transmission to the receiving base station or a neighboring base station; (2) a step in which the transmitting base station transmits a radio signal; (3) a step in which the receiving base station performs an object sensing operation based on a received signal; and (4) a step in which the receiving base station shares an object sensing result, and the like may be included.

In the step (step (1)) in which the transmitting base station delivers the configuration information related to signal transmission to the receiving base station or the neighboring base station, the transmitting base station may select specific frequency resources, time resources, or beam resources for signal transmission and object sensing. Here, the specific frequency resources, time resources, or beam resources may be referred to as wireless resources. Information on selecting the resources may be delivered in advance or before signal transmission to the receiving base station or the neighboring base station, and may be delivered directly between base stations via the Xn interface or delivered through a 5GC via the NG interface. Further, the resource selection information may be delivered together with the information that may be included in the configuration for radio signal transmission or the information that may be included in the configuration for sensing signal reception.

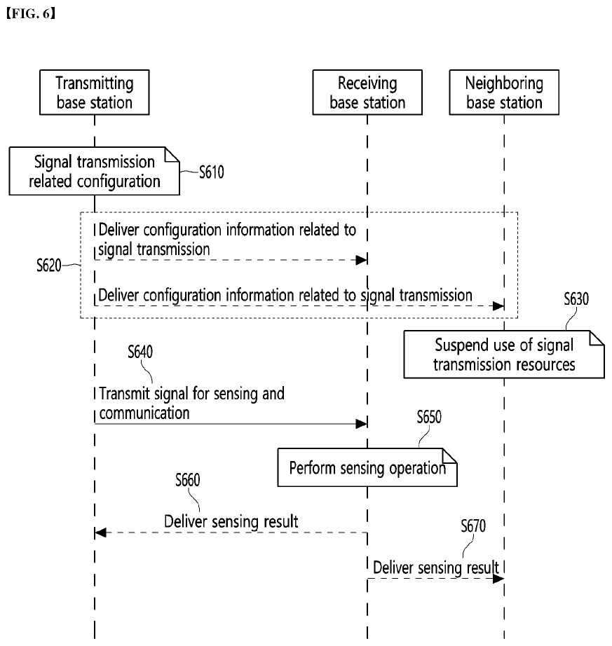

In the step (step (2)) in which the transmitting base station transmits the radio signal, the transmitting base station transmits a signal for sensing and communication by using the frequency resources, time resources, or beam resources selected in the step in which the transmitting base station delivers the configuration information related to signal transmission to the receiving base station or the neighboring base station. In this case, resources for the sensing and resources for the communication may be transmitted with being separated in a frequency domain, a time domain, or a beam domain, or may be transmitted without being separated. Meanwhile, as in an operation example of FIG. 5, the neighboring base station that has shared the resource selection information may avoid use of the selected frequency resources, time resources, or beam resources such that the neighboring base station does not cause interference to the receiving base station that senses the sensing signal. FIG. 5 is a diagram illustrating an example of a base station-to-base station bistatic scheme proposed in the present disclosure.

In the step (step (3)) in which the receiving base station performs the object sensing operation based on the received signal, the receiving base station performs the object sensing operation through signal reception based on the configuration for sensing signal reception and the resource selection information received from the transmitting base station or the core network.

In the step (step (4)) in which the receiving base station shares the object sensing result, the receiving base station performs an operation of delivering a sensing result to the transmitting base station, the neighboring base station, or the core network. The sensing result of the receiving base station may include presence or absence of a sensed object, the number of sensed objects, a size of the sensed object, a distance to the sensed object, a direction of the sensed object, and the like. Meanwhile, delivery of the sensing result of the receiving base station may be performed by using the Xn interface or the NG interface.

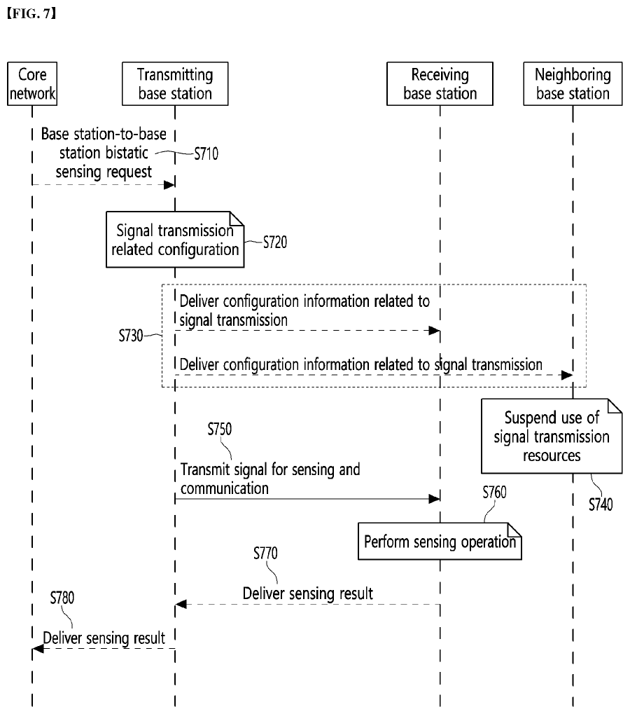

FIG. 6 is a flowchart illustrating an example of an operation for base station-to-base station bistatic sensing and a signal transmission and reception method proposed in the present disclosure.

Referring to FIG. 6, the transmitting base station (or a first base station) sets signal transmission related information for a base station-to-base station bistatic sensing scheme (S610).

The transmitting base station transmits signal transmission related configuration information to a receiving base station and/or a neighboring base station (S620). The signal transmission related configuration information may be included in a control message and transmitted.

When the neighboring base station receives the signal transmission related configuration information, the neighboring base station suspends use of signal transmission resources indicated by the signal transmission related configuration information such that the neighboring base station does not cause interference to the receiving base station (S630).

The transmitting base station transmits the signal for sensing and communication to the receiving base station (S640). The signal for sensing and communication may be multiplexed and transmitted to the receiving base station.

The receiving base station receives the signal transmitted in step S640 and performs a sensing operation (S650).

The receiving base station transmits a result for sensing in step S650, that is, a sensing result, to the transmitting base station and/or the neighboring base station (S660).

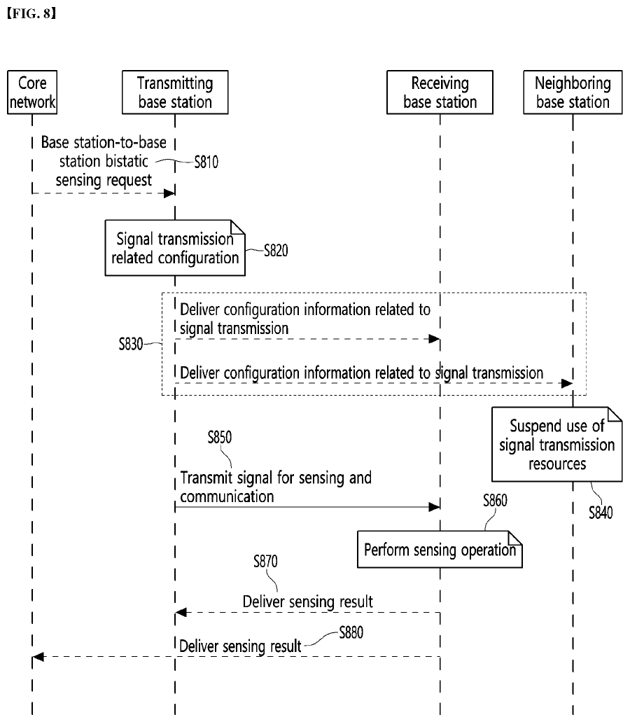

FIGS. 7 and 8 are flowcharts illustrating other examples of the operation for base station-to-base station bistatic sensing and the signal transmission and reception method proposed in the present disclosure.

More specifically, FIGS. 7 and 8 relate to a method including an operation of receiving a sensing request from a core network or an external Internet network in relation to transmitting base station and receiving base station operations and signal delivery for base station-to-base station bistatic sensing, performing sensing operation between the transmitting base station and the receiving base station, and then delivering a sensing result to the core network or the external Internet network. As illustrated in FIG. 7, the core network transmits a base station-to-base station bistatic sensing request to the transmitting base station (S710), and the transmitting base station delivers the sensing result of the receiving base station to the core network (S780). Since steps (S720 to (S770 in FIG. 7 other than steps (S710 and (S780 are the same as steps S610 to S660 in FIG. 6, reference is made to FIG. 6 for detailed description of the steps.

Further, as illustrated in FIG. 8, the core network transmits the base station-to-base station bistatic sensing request to the transmitting base station (S810), and the receiving base station also transmits the sensing result of the receiving base station to the transmitting base station (S870) and directly transmits the sensing result also to the core network (S880). Since steps S820 to S870 in FIG. 8 other than steps S810 and S880 are the same as steps S610 to S660 in FIG. 6, reference is made to FIG. 6 for detailed description of the steps.

Based on the above, an operation of the transmitting base station proposed in the present disclosure may include transmitting first configuration information related to configuration for the communication and second configuration information related to configuration for the sensing to at least one of a receiving base station and a neighboring base station; determining wireless resources used for the communication and the sensing; transmitting a radio signal to the receiving base station on the wireless resources; and receiving a result for the sensing from the receiving base station.

The result for sensing may include at least one of information on presence or absence of a sensed object, information on the number of sensed objects, information on a size of the sensed object, information on a distance to the sensed object, or information on a direction of the sensed object.

Additionally, the transmitting base station may receive a request for sensing from the core network, and may transmit the result for sensing to the core network.

Further, the wireless resources may include resources related to transmission of the radio signal for the communication and resources related to reception of the radio signal for the sensing, and the wireless resources may include at least one of specific frequency resources, time resources, and beam resources.

The information on the wireless resources may be included in the first configuration information or the second configuration information, and the first configuration information and the second configuration information may include at least one of a sensing mode identity for distinguishing between sensing modes, information on the number of target objects, information for target object distinguishment, information for distinguishing a base station performing sensing, frequency allocation information, time allocation information, bandwidth part (BWP) information, information on a waveform to be used, information on a slot format, information on a reference signal, information on multiple antennas, and information on beamforming.

The first configuration information and the second configuration information may be delivered via the Xn interface or may be delivered over a core network via the core Ng interface.

Further, a method for operating a receiving base station proposed in the present disclosure may include receiving first configuration information related to configuration for communication and second configuration information related to configuration for sensing from the transmitting base station, receiving a radio signal on wireless resources used for the communication and the sensing, performing sensing based on the received radio signal, and transmitting a result for the sensing to the transmitting base station.

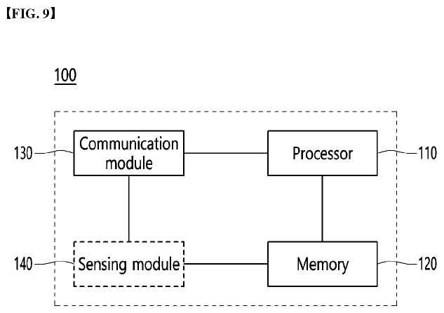

FIG. 9 is a block configuration diagram of a wireless apparatus according to one embodiment of the present disclosure.

A wireless apparatus 100 may be a core network (CN), a base station, a user equipment, or the like.

The wireless apparatus may include a processor 110, a memory 120, a communication module 130, a sensing module 140, and the like.

The processor implements the functions, processes, and/or methods proposed in FIGS. 1 to 8 above. Layers of wired/wireless interface protocols may be implemented by the processor. The memory is connected to the processor to store various types of information for driving the processor. The communication module is connected to the processor to transmit and/or receive wired/radio signals.

The communication module may include an antenna for transmitting/receiving a radio signal.

The sensing module may be included only in a wireless apparatus that performs sensing, and may not be included in a wireless apparatus that does not perform sensing.

The embodiments described above are those in which components and features of the present disclosure are combined in a predetermined form. Each component or feature should be considered optional unless explicitly stated otherwise. Each component or feature may be embodied in a form in which the component or feature is not combined with other components or features. Further, it is also possible to configure an embodiment of the present disclosure by combining some components and/or features. Order of operations described in the embodiments of the present disclosure may be changed. Some configurations or features of an embodiment may be included in another embodiment or replaced with corresponding configurations or features of the other embodiment. It is obvious that embodiments can be configured by combining claims that do not have an explicit citation relationship in the claims, or can be included as new claims by amendment after filing.

An embodiment according to the present disclosure may be implemented by various means, such as hardware, firmware, software, or a combination thereof. When the embodiment of the present disclosure is implemented by the hardware, the embodiment may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When the embodiment of the present disclosure is implemented by the firmware or software, the embodiment of the present disclosure may be implemented in the form of, for example, modules, procedures, or functions of performing the functions or operations described above. Software code may be stored in a memory and driven by a processor. The memory may be located inside or outside the processor to exchange data with the processor by various means already known.

It is obvious to those skilled in the art that the present disclosure can be embodied in other specific forms without departing from essential features of the present disclosure. Therefore, the above detailed description should not be construed as being restrictive in all respects and should be considered as being illustrative. The scope of the present disclosure should be determined by reasonable interpretation of the appended claims, and all changes within an equivalent scope of the present disclosure are included in the scope of the present disclosure.

What is claimed is:

1. A method performed by a transmitting base station for performing communication and sensing in a wireless communication system supporting integrated sensing and communication (ISAC), the method comprising:
transmitting, to at least one of a receiving base station and a neighboring base station, first configuration information related to configuration for the communication and second configuration information related to configuration for the sensing;
determining, based on the first configuration information and the second configuration information, wireless resources configured for the communication and the sensing;
transmitting, to the receiving base station and via the wireless resources, a radio signal; and
receiving, from the receiving base station, sensing information associated with the sensing.

2. The method of claim 1, wherein the sensing information comprises at least one of:
information on presence or absence of a sensed object,
information on a number of sensed objects,
information on a size of the sensed object,
information on a distance to the sensed object, or
information on a direction of the sensed object.

3. The method of claim 1, further comprising:
receiving, from a core network, a request for the sensing from a core network.

4. The method of claim 3, further comprising:
transmitting, to the core network, the sensing information.

5. The method of claim 1, wherein the wireless resources comprise resources related to transmission of a radio signal for the communication and resources related to reception of a radio signal for the sensing.

6. The method of claim 1, wherein the wireless resources comprise at least one of specific frequency resources, time resources, or beam resources.

7. The method of claim 1, wherein at least one of the first configuration information or the second configuration information comprises information on the wireless resources.

8. The method of claim 1, wherein the first configuration information and the second configuration information comprise at least one of:
a sensing mode identity for distinguishing between sensing modes,
information on a number of target objects,
information for distinguishing a target object,
information for distinguishing a base station performing sensing,
frequency allocation information,
time allocation information,
bandwidth part (BWP) information,
information on a waveform,
information on a slot format,
information on a reference signal,
information on multiple antennas, or
information on beamforming.

9. The method of claim 1, wherein the transmitting of the first configuration information and the second configuration information comprises transmitting the first configuration information and the second configuration information via at least one of an Xn interface or over a core network via a core Ng interface.

10. The method of claim 8, wherein the sensing mode identity comprises information indicating monostatic sensing or bistatic sensing.

11. The method of claim 10, wherein the sensing mode identity further comprises information indicating at least one of base station monostatic sensing, user equipment monostatic sensing, base station-to-base station bistatic sensing, base station-to-user equipment bistatic sensing, user equipment-to-base station bistatic sensing, or user equipment-to-user equipment bistatic sensing.

12. The method of claim 8, wherein the information on the waveform comprises information indicating at least one of orthogonal frequency-division multiplexing (OFDM) or discrete frequency transform-spread-OFDM (DFT-s-OFDM).

13. The method of claim 8, wherein the information on the slot format comprises:
arrangement information for at least one of downlink, uplink, sidelink, or flexible sections in a slot, and
a slot format index for a plurality of predetermined slot format candidates.

14. The method of claim 8, wherein the information on multiple antennas comprises information on at least one of a number of layers for multiple antenna transmission or a number of antennas.

15. The method of claim 8, wherein the information on beamforming comprises at least one of a number of beams or a beam identity.

16. A method performed by a receiving base station for performing communication and sensing in a wireless communication system supporting integrated sensing and communication (ISAC), the method comprising:
receiving, from a transmitting base station, first configuration information related to configuration for the communication and second configuration information related to configuration for the sensing;
receiving, via wireless resources configured for the communication and the sensing, a radio signal;
performing, based on the received radio signal, the sensing; and
transmitting, to the transmitting base station, sensing information associated with the sensing.

17. The method of claim 16, wherein the sensing information comprises at least one of:
information on presence or absence of a sensed object,
information on a number of sensed objects,
information on a size of the sensed object,
information on a distance to the sensed object, or
information on a direction of the sensed object.

18. The method of claim 16, further comprising transmitting the sensing information to a neighboring base station.

19. The method of claim 16, further comprising transmitting the sensing information to a core network.

20. A transmitting base station for performing communication and sensing in a wireless communication system supporting integrated sensing and communication (ISAC), the transmitting base station comprising:
a communication interface configured to transmit and receive signals;
a processor; and
a memory storing instructions configured to be executed by the processor to cause the transmitting base station to:
transmit, to at least one of a receiving base station and a neighboring base station via the communication interface, first configuration information related to configuration for the communication and second configuration information related to configuration for the sensing,
determine, based on the first configuration information and the second configuration information, wireless resources configured for the communication and the sensing,
transmit, to the receiving base station and using the wireless resources via the communication interface, a radio signal, and
receive, from the receiving base station via the communication interface, sensing information associated with the sensing.
